(19) United States
(12) Patent Application Publication
(10) Pub. No.: US 2003/0148006 A1
(43) Pub. Date: Aug. 7, 2003

(54) Seasoning mixture with a high salt content

(76) Inventors: Baudouin Vicomte van Aefferden, Dissen (DE); Dietmar Hermey, Dissen (DE)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/220,161

(22) PCT Filed: Feb. 22, 2001
(86) PCT No.: PCT/EP01/02005

(30) Foreign Application Priority Data
Feb. 23, 2000 (DE) 100-08-156.8

(51) Int. Cl. A23G 1/00

(52) U.S. Cl. 426/293

(57) ABSTRACT

The invention relates to a seasoning mixture containing a liquefiable fat for the food industry with a salt content from about 15 to 67 wt %, relative to the weight of the seasoning mixture, or a seasoning mixture with a salt content from about 15 to 67 wt %, relative to the weight of the seasoning mixture, wherein the liquefiable agent is selected from the group consisting of hydrocolloids, gelatine, emulsifiers and carbohydrates, wherein, after the seasoning mixture has been applied to the article to be seasoned, an even, solid layer is formed on the latter as said seasoning mixture solidifies.

The invention relates to a seasoning mixture for foodstuffs, especially meat and poultry, with a particularly high salt content and a method of seasoning foodstuffs using this seasoning mixture.

For the commercial preparation of large quantities of poultry, the latter is treated with marinades, salt solutions or dry seasoning mixtures in tumblers. This process does not ensure that the desired quantity of spice or salt is still present on the foodstuffs after the treatment. A further disadvantage of this process is that the poultry has to be taken off the conveyor belt, placed in the tumbler and then returned to the conveyor belt after being treated for about 20 minutes. The use of this process first of all wastes time, and secondly, if there is any poultry in the tumbler which is contaminated with germs, it will come into contact with other poultry which is not contaminated. This compromises the hygienic safety of the entire batch. A further disadvantage of the treatment in the tumbler is that the poultry can be deformed.

By way of alternative, the poultry may be seasoned in smaller rotisseries by painting the marinade or salt solutions on with a brush.

The object of the invention is to obtain a high-quality seasoned foodstuff, especially poultry, by means of treatment for the shortest possible time.

This object is achieved by means of a seasoning mixture containing a liquefiable fat with a salt content of about 15 to 67 wt %, based on the weight of the seasoning mixture. A further object of the invention is a method of seasoning foodstuffs using the above-mentioned seasoning mixture.

This object is also achieved by means of a seasoning mixture with a salt content of about 15 to 67 wt %, based on the weight of the seasoning mixture, which further contains a liquefiable agent, selected from the group consisting of hydrocolloids, gelatine, emulsifiers and carbohydrates. These liquefiable seasoning mixtures, which do not contain any fat, can also be used in the mixture with a liquefiable fat.

A further object of the invention is a foodstuff coated with the seasoning mixture of the invention. Preferably, the seasoning agent forms a solid layer, as closed as possible, on the foodstuffs. The layer covering the foodstuff can be 0.1 to 2 mm, preferably 0.3 to 1 mm, thick. A closed, film-like coating of this kind is not achieved with conventional seasoning.

Finally, other objects of the invention are methods of seasoning the foodstuffs with the seasoning mixture of the invention in order to obtain the foodstuff coated with the seasoning mixture. The seasoning can also be effected in such a way that first of all the liquefiable material, optionally with spices and additives, and subsequently salt is applied to the foodstuffs. It is also possible to proceed in the opposite order. The crucial point with this process, too, is to achieve a solid layer of seasoning, which should be as closed as possible, on the foodstuff.

The seasoning mixture of the invention is characterised by an extraordinarily high salt concentration for seasoning mixtures to be applied in liquid form. The salt content is so high that, when the seasoning mixture is used in liquid form, most of the salt is present in solid form, distributed homogeneously in the viscous mixture. It is considered surprising that, after resolidification, this seasoning mixture forms an even layer on the article to be seasoned. This kind of distribution on the article to be seasoned means that no dewatering effects because of the high salt concentration occur during storage.

This layer on the surface of the foodstuff gives rise to a better capacity for retaining salt and spices on the foodstuffs and also protects the foodstuff against partially drying out and charring during grilling or roasting. This is not ensured with known dry seasoning mixtures. Unlike the known marinades, the seasoning mixtures of the invention remain on the article after the foodstuffs have been treated and do not run off it. The seasoning mixtures of the invention produce substantially better visual and taste effects on the foodstuffs than the marinades and dry seasoning mixtures used in the past. In particular, it is possible, in accordance with the invention, to avoid a situation in which, when the article is packaged in a foil or film under vacuum, the seasoning mixture is drawn into the voids formed when the vacuum is applied, as usually happens with marinades. It is also advantageous that the seasoning agent is not spread over the item after packaging.

A further advantage that can be achieved with the seasoning mixture of the invention consists in the fact that, for example, poultry does not have to be removed from the conveyor belt for seasoning when the seasoning mixture of the invention is applied to the foodstuff.

Before use, the seasoning mixtures of the invention are present in solid form as mixtures of salt and fat, optionally together with other seasoning substances and additives. During use, the seasoning mixtures of the invention are liquid and can have a viscosity of 380 to 2,000 mPas at application temperature, measured with a Haake Viscotester 6R (spindle R4, 100 revs./sec.). The solid, e.g. powdery, seasoning mixtures liquefy when heat is applied, as the fat melts. Even in the event that the seasoning agents of the invention do not contain any fat, liquefaction can be achieved by heating or by mixing the liquefiable agent or seasoning mixtures which do not contain fat with water. These agents solidify on cooling.

The salt content of the seasoning mixtures of the invention is preferably 20 to 60 wt %, or, according to a further preferred embodiment, 30 to 55 wt %, relative to the weight of the seasoning mixture. Salts used in accordance with the invention are preferably common salt or mixtures of common salt and inorganic salts, organic salts or mixtures thereof. The salts to be used in accordance with the invention can also comprise mineral components. The salt can be of particle sizes commonly found in the household, or it may be very finely particulate.

It has proven advantageous to use silica gels. Silica gels enhance the pourability of the dry seasoning mixtures, which are based on solid fats, and facilitate the production and packaging of the latter.

The fats used in the seasoning mixtures of the invention are those with a melting or solidification point above about −5° C., and preferably above 10 or 20 to 60° C. Fats of this kind can be hydrogenated vegetable and animal or hydrogenated vegetable and animal fats, such as beef suet, hydrogenated soya oil, or palm kernel fat. Synthetic triglycerides, such as tripalmitate glycerine can also be suitable.

The liquefiable agents used in the seasoning mixtures of the invention instead of a fat or used in the mixture with one of the above-mentioned fats are those which are solid at least at temperatures in the range from 0° C. and lower to about 50° C., or those which are liquefiable by the addition of water and become solid after they have been applied to the cold foodstuffs. Agents of this kind may, for example, be hydrocolloids, i.e. water-soluble or partially water-soluble natural or synthetic polymers which form gels or viscous solutions in aqueous systems. By way of example, one might mention alginates, carrageen, pectin, polydextrose, polyvinyl alcohol, polyvinyl pyrrolidone and dextran. Other agents of this kind are gelatine and emulsifiers of the kind regularly used in food, which have the same melting properties as the above-mentioned fats. Other suitable agents, finally, are meltable polysaccharides and other carbohydrates, such as dextrose, xylitol and sugar alcohols such as sorbitol. This thus means that all edible materials are suitable which can form a layer on the foodstuff as part of the mixture with salt at the storage temperature of the foodstuff.

Furthermore, the seasoning mixture can contain spices, herbs, plants, extracts, flavourings, tea, coffee, vegetables, medicinal plants, dried or fresh seeds, whole, crushed or ground, and flavour enhancers. These additives can be added to the seasoning mixture in quantities of up to 50%, e.g. 10 to 40%.

The seasoning mixture can also contain thickening agents. Suitable thickening agents are those which are commonly used in the food industry, such as starch, gelatine, agar-agar, pectin products, guar flour, carob-bean flour and xanthan. The thickening agents can be used in quantities of up to 15 wt %, e.g. 0.1 to 12 wt %, relative to the weight of the seasoning mixture.

In addition, the seasoning mixture of the invention can contain adhesion promoters in quantities of up to 10 wt %, e.g. 1 to 8 wt %, relative to the weight of the dry seasoning mixture. Adhesion promoters of this kind are sugar substances, mixtures of different sugar substances and edible fibres. Suitable sugar substances are mono and disaccharides, such as glucose, maltose, fructose, mannose, saccharose, lactose, maltodextrin and inverted sugar. They can be added to the production of the seasoning mixture of the invention in the form of powders, solutions, and especially syrups.

The seasoning mixtures of the invention can contain further additives which are commonly used in the food industry. Examples of these are separating agents such as tricalcium phosphate, calcium stearate or earth alkali carbonates.

The seasoning mixture is suitable for seasoning poultry, poultry parts, meat, fish, vegetables and pasta dishes. During the treatment process with the seasoning mixture, meat can be at a temperature of 4 to 9° C., poultry at a temperature of about 2 to 9° C. and pasta at a temperature of 15 to 25° C. Other temperatures of the foodstuff to be seasoned are possible.

After liquefaction by heating, the seasoning mixture of the invention can be sprayed or brushed onto the article to be seasoned. Depending on the liquefiable material used, liquefaction is achieved by heating or by adding water. In addition, it is possible to dip the article to be seasoned into the liquid or viscous seasoning mixture. Both measures can be carried out on a conveyor belt, so that the article to be seasoned does not need to be removed from the processing line and subsequently returned to it for further processing.

According to a further embodiment of the invention, salt and the liquefiable material are applied to the foodstuff separately from one another. It is, for example, possible for the salt to be applied first in powder form or as a concentrated aqueous solution and for the liquefiable material to be applied after that. The other seasoning agents and any additives, whose use is optional, can be applied to the foodstuff together with the liquefiable material. This procedure can make sense if there is water or moisture on the surface of the foodstuff.

Fat and seasoning mixtures containing fat mixtures which are present in the form of powder at room temperature can be prepared by simply mixing the fat with the other ingredients of the seasoning mixture. When heated to temperatures above the melting point of the fat used, e.g. to 35 to 120° C., the seasoning mixture is liquefied. After it is applied to the relatively cold foodstuff the fat contained in the seasoning mixture solidifies, so that only a matter of seconds after being applied to the surface, the fat solidifies and a dry coating forms. This is also the case with the other liquefiable materials. Sorbitol is liquefied by heating to a temperature higher than 112° C., dextrose hydrate higher than 83° C. and xylitol higher than 94° C.

By way of example, the manufacture of a dry seasoning mixture will now be described. Liquid beef fat can be mixed with heated hydrogenated fat in such a way that the melting point of the mixture becomes so high that it can be stored at room temperature in a solidified state without becoming liquid. For this purpose, the heated fat mixture is placed in the form of flocs on a chill roll and the fat flocs are then mixed with the dry substances, such as salt and spices.

It is, however, possible to proceed as described above, with the dry substances being blended into the liquefied fat. After this, the mixture is cooled and the flocs are produced as described above.

It is also possible to work only part of the dry substances into the heated fat mixture and then to blend the rest of the dry substances with the fat flocs. This last-named embodiment imparts better pourability to the seasoning mixture and also makes it possible to keep the mixture dry better.

The fat flocs or fat floc mixture can be liquefied by the user in a heated container with a powerful stirrer, and the liquid mixture can be applied to the article to be seasoned via a nozzle.

Alternatively, a screw can receive the floc or dry mixture for this purpose, then compressing and liquefying it. Heating is achieved by friction and pressure, or with the additional application of direct heat. A nozzle can then be used to apply the liquid seasoning mixture to the article, on which the seasoning mixture then solidifies.

The seasoning mixture of the invention is suitable for use in the food industry in the industrial seasoning of foodstuffs. Chicken legs at a temperature of about 6° C., for example, are picked up by a conveyor means and transported in a hanging position past a nozzle means. The seasoning mixture of the invention is sprayed through nozzle means onto the foodstuff, which is rotated in the process, so that the seasoning is applied evenly from all sides.

In accordance with a particularly preferred embodiment, before being sprayed with the seasoning mixture, the article to be seasoned is dusted with a powdery substance which is able to absorb the moisture on the surface of the article to be seasoned. This substance can, for example, be a conventional thickening agent, separating agent, flour, starch or maltodextrin.

The invention will now be explained in more detail with reference to the following examples.

### EXAMPLE 1

Formulation A

| Ingredients of the seasoning mixture | Content [wt %] |
|---|---|
| Suet, flocculated | 28.3 |
| Hydrogenated vegetable fat | 4.5 |
| Common salt | 59.0 |
| Separating agent (Sipernat ® 22S) | 1.0 |
| Emulsifier | 1.0 |
| Maltodextrin | 5.9 |
| Xanthan gum | 0.3 |
| | Σ = 100.0 |

Formulation B

| Ingredients of the seasoning mixture | Content [wt %] |
|---|---|
| Suet, flocculated | 17.0 |
| Hydrogenated vegetable fat | 17.0 |
| Common salt | 43.0 |
| Separating agent (Sipernat ® 22S) | 1.0 |
| Spices | 21.0 |
| Emulsifier | 1.0 |
| | Σ = 100.00 |

The seasoning mixtures were heated to a temperature of 80° C. and held at that temperature. In the meantime, a two-fluid nozzle (GAV jet wash pistol, Westfalia) was raised to 90 to 110° C. in a heating cabinet. The heated seasoning mixture was poured into the liquid reservoir of the pistol and sprayed, at a pressure of 4 to 8 bar and from a distance of 30 to 50 cm, onto the poultry, which was at a temperature of 6° C.

The seasoning agent solidified immediately after striking the cold poultry, forming an even film thereon.

### EXAMPLE 2

Sprayable Dry Seasoning on the Basis of a Hydrocolloid

| Ingredients (Formulation C) | Content [wt %] |
|---|---|
| Seasoning agent | 28.8 |
| Methyl cellulose | 4.3 |
| Maltodextrin | 5.8 |
| Guar kernel flour | 3.2 |
| Salt | 57.9 |

A 5% solution of agar-agar at a temperature of 80° C. was sprayed onto chicken legs, the quantity being about 1.5 wt %, relative to the weight of the chicken legs. Immediately after that, the dry seasoning of the formulation shown in the above table was sprayed through the same nozzle means in a quantity of 0.6 wt %, relative to the weight of the chicken legs. The temperature of the chicken legs was 6° C. The material sprayed on solidified after about a minute and was sufficiently firm to the touch for the legs to be placed in packaging.

### EXAMPLE 3

Formulations D and E and the comparative formulations CF and CG were prepared and had the composition shown in the following table. All the numbers shown in the table indicate grams (g).

| Ingredients | D | E | CF | CG |
|---|---|---|---|---|
| Suet, flocculated | 367.5 | — | — | — |
| Palm kernel oil | — | 350 | — | — |
| Hydrogenated | 52.5 | 50 | — | — |
| vegetable fat | | | | |
| Common salt | 100 | 500 | 100 | 500 |
| Separating agent | 17.5 | 17.5 | — | — |
| Emulsifier | 11.25 | 11.25 | — | — |
| Thickener | 4.0 | 4.0 | — | — |
| Adhesion promoter | 280 | 50 | 350 | — |
| Seasoning agent | 250 | 250 | 250 | — |
| (excluding salt) | | | | |

All the dry mixtures exhibited very good pourability, the samples according to the invention exhibited good flowability at 50° C. Sample D exhibited very good flowability.

Pork cutlets were sprayed with about 10 wt % of the spray seasoning, relative to the weight of the cutlets. For comparison, some cutlets were rubbed with 3.5 wt % of the dry seasoning, relative to the weight of the cutlets. All the samples were packed in plastic foil and left in the refrigerator overnight. The temperature in the refrigerator was 4° C.

After that, the cutlets were fried under identical conditions (pan, heat, time) and compared by a sensory test. The appearance of the fried foodstuff, the aroma of the spice mixture in terms of its strength and profile and the salt strength were evaluated. Marks were given on a scale ranging from very good (1) to very poor (5) and with an indication > (too strong) and < (too weak), and O.K. (no complaints).

Evaluation

| Properties to be tested | D | CF |
|---|---|---|
| Impression of salt content | 1 | 2-3 |
| Adhesion of the spices during | 2 | 4 |
| frying | | |
| Aroma development in the cutlet | 1 | 3 |
| Layer like breadcrumbs | 2 | no |
| Browning on the cutlet | 2 | >> |
| Other remarks | — | Tendency to |
| | | burn |

With spray-seasoning, a distinct improvement in the capacity for seasoning was observed. The salt taste and the aroma were felt to be distinctly more intensive compared to conventional dry seasoning. Furthermore, spraying on the seasoning agent made it possible to place ingredients on the cutlet which form a crispy crust during frying, which makes the cooked foodstuff look and feel breadcrumbed. Apart from this crispy surface, other experiments have shown that increasing the proportion of sugars substances in the seasoning mixture or the proportion of starch-containing components (wheat flour/starch as an adhesion promoter) leads to a more even or more intensive browning of the surface of the foodstuff. The formation of reaction aromas resulting from the presence of reactants in the seasoning mixtures is encouraged more than in dry mixtures.

With seasoning mixture E, a dry chicken was sprayed with a quantity of 1.25 wt %, relative to the weight of the chicken. During spraying, the chicken was at a temperature of 7° C., the seasoning sprayed on was at a temperature of 80° C. The latter solidified immediately after impinging on the surface of the foodstuff.

For comparative purposes, the same type of chicken at a temperature of 5 to 7° C. was treated for 30 minutes with a dry seasoning in a quantity of 0.75 wt %, relative to the weight of the chicken, in the laboratory tumbler.

The chickens were packed in a film, placed in the refrigerator overnight, and then grilled the next day in a rotisserie with rotating skewers. In this way, it was ensured that the two chickens were cooked under identical conditions. After being grilled for 45 minutes, the chickens were subjected to a sensory comparison. The evaluation related to the appearance, the aroma of the spice mixture in terms of its strength and profile, and the strength of the salt. The evaluation was performed using the pattern described above.

Evaluation

| Properties to be tested | E | CF |
|---|---|---|
| Impression of salt content | 1 | < |
| Aroma development in the meat | 1 | < |
| Salt distribution | 1 | 3 |
| Browning of the skin | 1-2 | 3 |
| Juice content in the meat | 1 | 3 |
| Other remarks | — | Tendency to |
| | | burn |

With the spray-on seasoning, a distinct improvement in the capacity for seasoning was observed, and in addition, it was found that the skin always appeared juicier during grilling compared to the traditional seasoning. In the taste test, the degree of moisture of the sprayed chicken was also noticeable. The meat was distinctly juicier after cooking.

Similar studies were also carried out with chicken legs, though these were cooked for 45 minutes in a fan-assisted oven at a temperature of 150° C. Even though the same substances and the same quantity of salt were used for seasoning, the sprayed food samples had a more intensive salt taste and a more intensive aroma. Moreover, with the traditionally seasoned chicken legs, the skin tended to burn and dry out.

1. Method of seasoning foodstuffs, characterised in that salt and liquefiable fat are applied to the foodstuff in a form applicable as a liquid and the fat is allowed to solidify, forming a salt-containing, solid layer on the foodstuff.

2. Method as claimed in claim 1, characterised in that a seasoning mixture applicable as a liquid and containing the fat, salt and optionally other components is applied to the foodstuff.

3. Method as claimed in claim 2, characterised in that a seasoning mixture containing the liquefiable fat in a non-liquefied form and, in a ratio of about 15 to about 67 wt. %, relative to the weight of the seasoning mixture, salt, is heated to such extent that the seasoning mixture can be applied in liquid form, and this mix is then applied to the foodstuff.

4. Method as claimed in claims 1 to 3, characterised in that the fat used in the seasoning mixture is one which has a melting point of more than about 10° C.

5. Method as claimed in any of claims 1 to 3, characterised in that the proportion of fat is 30 to 45 wt. %, relative to the weight of the seasoning mixture.

6. Method of seasoning foodstuffs, characterised in that salt and a mix applicable as a liquid and containing a liquefiable material selected from the group coning of hydrocolloids, gelatine, emulsifiers and carbohydrate, is applied to the foodstuff and the mix is allowed to solidify, forming a salt-containing, solid layer on the foodstuff.

7. Method as claimed in claim 6, characterised in that the mix applicable as a liquid comprises a seasoning mixture containing the liquefiable material, salt and optionally other components.

8. Method as claimed in claim 7, characterised in that the seasoning mixture is blended with water or an aqueous solution to such an extent that the mix can be applied as a liquid and this mix is then applied onto the foodstuff.

9. Method as claimed in any of claims 2 to 5 and 7 to 8, characterised in that the salt content is 20 to 45 wt. %, relative to the weight of the seasoning mixture.

10. Method as claimed in any of claims 2 to 5 and 7 to 9 characterised in that the seasoning mixture contains thickeners of the kind commonly used in the foodstuffs industry.

11. Method as claimed in any of claims 2 to 5 and 7 to 10, characterised in that the seasoning mixture contains adhesion promotors such as sugar substances, emulsifiers, protein substances, starch and/or vegetable fibres.

12. Method as claimed in any of claims 2 to 5 and 7 to 11, characterised in that the seasoning mixture contains mineral ingredients such as silicon dioxide and/or titanium dioxide.

13. Method as claimed in any of the preceding claims, characterised in that the mix to be applied is sprayed onto the foodstuff.

14. Method as claimed in any of claims 1 to 12, characterised in that the foodstuff is dipped into the mix to be applied.

15. Foodstuff obtainable using a method as claimed in any of claims 1 to 14.

16. Foodstuff as claimed in claim 15, characterised in that the foodstuff is selected from the group consisting of poultry, poultry parts, meat, fish, vegetables and pasta dishes.
